(19) United States
(12) Patent Application Publication
(10) Pub. No.: US 2020/0219218 A1
(43) Pub. Date: Jul. 9, 2020

(54) Career Readiness and Planning System

(71) Applicant: Aisha Dominique DaCosta-Paul, Ellicott City, MD (US)

(72) Inventor: Aisha Dominique DaCosta-Paul, Ellicott City, MD (US)

(73) Assignee: I AM O'KAH!, INC., BALTIMORE, MD (US)

(21) Appl. No.: 16/111,118

(22) Filed: Jan. 4, 2019

(51) Int. Cl. G06Q 50/20; G06Q 10/10; G06F 16/2455

(52) U.S. Cl. CPC G06Q 50/2057; G06F 16/2455; G06Q 10/1053

(57) ABSTRACT

A system and method for matching candidates to employment positions is disclosed. Measures of employee profile and other necessary traits and optionally interests are used to match candidates to employment positions. Opportunities are group into six categories career exposure, professional network connections, skills and training, internship experiences, education and entry-level employment programs. Software and computer systems embodying the method are also disclosed.

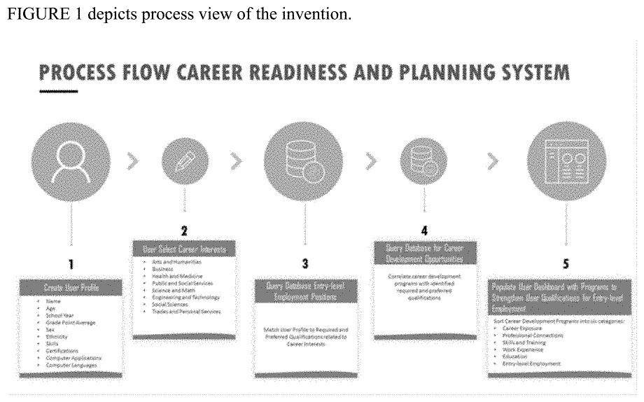

### NOTICE OF COPYRIGHTED MATERIAL IN DISCLOSURE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Field of the Invention

The present invention relates to a technique for matching potential employees with potential employers over a network, and more particularly to matching employers needs with potential employees using traditional employment information. This app responds to the user on behalf of the selection of user. The app responds to selection of the user where, the system determines and displays the details on user output screen.

### Description of the Related Art

Locating a suitable candidate for an available employment position is typically a difficult task. The traditional job application process requires interested candidates to submit a resume in response to a job availability advertisement. Such advertisements set out job requirements, typically in the form of desired or required job skills. The resumes, in turn, include the educational, employment, skill, and personal interests of the candidates. The employers on the basis of that scrutinize the best selected candidate as per their requirement.

With the advent of latest technology many types of advancements have been seen in this field which not only promise to reduce the cost and time of traditional recruitment process but also provide a system which brings a healthy pool of prospective employees.

One of the present systems which most of the companies have acquired constitute of an employment system is any electronic system which facilitates those looking for a position (i.e., employment seekers, or job seekers) in finding a position and/or which facilitates those seeking to fill a position (i.e., employee seekers, or employers) in finding someone to fill the position. Typical employment systems enable employers to post available positions, and further enable job seekers to search available positions for positions that meet some search criteria. Some employment systems enable job seekers to post a resume, and further enable employers to search for resumes that contain certain keywords. However, traditional employment systems are inefficient for many reasons.

Employers have difficulty finding desirable candidates for positions by searching resumes on an employment site because information is not necessarily presented in a uniform manner for each resume. Typically, an employer enters one or more keywords and the database of job seeker resumes are searched to determine which resumes contain the keywords. Similarly, job seekers enter keywords upon which the database of available jobs are searched. Thus, if an ideal job seeker leaves pertinent information (e.g., language experience, a certification, security clearance level, etc.) out of a resume or even puts the information into the resume without using the keywords searched upon (e.g., using synonyms or containing a typo), the employer may never find the ideal job seeker's resume. Boolean searches (searches using keywords and/or strings that can be resolved to truth values in addition to Boolean operators such as AND, OR and NOT) may provide improved search results, but still suffers from the same problem. Further, a keyword and/or Boolean search may generate many false-positive results because the keyword is present in a resume but not in the correct context. Such false-positive results waste the potential employer's time.

There are multiple approaches that have been found in prior art at multiple patent office. For instance a Job matching system and method having U.S. Pat. No. 7,502,748,B1 issued to Careerious Inc is a system for matching employment candidates to employment positions is disclosed. Measures of personality traits and optionally interests are used to match candidates to employment positions. Candidates' traits may be assessed by administering a questionnaire. A similar questionnaire may be provided to suitable employees who are already filling, or have previously filled, employment positions, in order to assess personality traits of suitable employees for each position. Results are preferably received and compared. A list of suitable jobs may then be provided to the candidate. Software and computer systems embodying the method are also disclosed.

Another Match-based employment system and method issued to CITIZENS BANK OF PENNSYLVANIA is A method of operating an employment system is provided. The method includes generating a score for each of a plurality of possible results compared to information associated with a user, enabling the user to access a result of the plurality of possible results if the score generated for the result meets a threshold condition, enabling the user to adjust the threshold condition and preventing the user from adjusting the threshold condition beyond a minimum threshold condition. The score can be a bi-directional matching score. The minimum threshold condition can include a minimum score. The minimum score can be determined based on the percentage of the plurality of possible results that would be accessible to the user.

Another US20020103680A1 patent issued to Newman Les A. is a system, method and computer program product for managing the provision and administration of employee benefits is herein provided. The system, method and computer program product of the present invention electronically accepts and stores data related to employee benefits and allows users to alter that data according to desired parameters. The system, method and computer program product also includes a communication function that enables electronic employee benefit data to be transmitted among modules of the data processing system or computer program product and also among various users of the invention.

Rights management information system patent issued to Intertrust Technologies Corp is used at least in part in a matching, narrowcasting, classifying and/or selecting process. A matching and classification utility system comprising a kind of Commerce Utility System is used to perform the matching, narrowcasting, classifying and/or selecting. The matching and classification utility system may match, narrowcast, classify and/or select people and/or things, non-limiting examples of which include software objects. The Matching and Classification Utility system may use any pre-existing classification schemes, including at least some rights management information and/or other qualitative and/or parameter data indicating and/or defining classes, classification systems, class hierarchies, category schemes, class assignments, category assignments, and/or class membership. The Matching and Classification Utility may also use at least some rights management information together with any artificial intelligence, expert system, statistical, computational, manual, or any other means to define new classes, class hierarchies, classification systems, category schemes, and/or assign persons, things, and/or groups of persons and/or things to at least one class.

A U.S. Pat. No. 7,043,443B issued to Firestone Lisa M A system and method for matching potential employees with potential employers over a network. Potential employers provide position information for one or more job openings over the network to a employee recruitment, job matching and job placement system. Case workers work with potential employees in assessing the potential employees and providing the potential employee's job qualification information, physical and behavioral health information and social needs over the network to the employee recruitment, job matching and job placement system. The employee recruitment, job matching and job placement system compares the information for the potential employee with the position information for at least one job opening and generates a list of job openings and corresponding matching percentages. A matching percentage is the percentage of the received information from the potential employee matches the position information for a job listing of a potential employer. The employee recruitment, job matching and job placement system generates a job placement plan indicating physical rehabilitation accommodation, health education and training needs if applicable for the job listings selected by the potential employee.

All of the above systems that are mentioned are complex and have their own pre-requisite to transfer money. Hence It is desirable to provide a communication system and money transfer system that does not require technical knowledge, but rather allows a user to chat and transfer money easily.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is a basic object of the present invention to automate the process of job search, job matching till applying for the job and make the processes more easily accessible to perspective employers and employees.

The primary object of the invention related to a method proposing an insight to the user by employer detailing the job descriptions regarding minimum and desired qualifications to aid users career preparation and planning by matching users with opportunities that will increase their ability to meet potential employer requirements.

It is further the objective of the invention to access user's current academic and career credentials and based on that identify career interests, and match with available opportunities which will help increase their competitiveness for desired employment based on employer identified qualifications.

it is further the objective of the invention to allow users a access social networking which is integrated into the system to facilitate career-planning support from caring adults, mentors, parents and school administrators.

It is further the advantage of the present invention which allow substantial amount of information and tools related to employee benefit processes will be consolidated into a single source.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### SPECIFICATIONS

The present invention is a employee recruitment, job matching and job placement system and method for matching individuals with potential employers over a network using traditional employment information. The present invention relates to systems, methods and computer program products used for analyzing, modeling a variety of employment opportunities and employees.

It has been found out that there is a persistent gap between employer expectations for entry-level employees and the skills and credentials of applicants entering the workforce post-secondary education. The proposed system in its preferred embodiment uses insight from employer job descriptions regarding minimum and desired qualifications to aid users career preparation and planning by matching users with opportunities that will increase their ability to meet potential employer requirements.

The systems in its additional embodiment uses advance algorithm that correlates the minimum and desired qualifications cited by employers in job descriptions to programs and opportunities for users to attain the qualifications identified by potential employers. Based on user's current academic and career credentials and identified career interests, users are matched with available opportunities that will help increase their competitiveness for desired employment based on employer identified qualifications.

The system in its further embodiment based on user's career interest selection database queries entry-level job posts for minimum and preferred requirements and returns to user the employment opportunities that qualify for that user based on his/her academic performance (GPA, technical courses and grade level).

The system in its further embodiment based on users' career interest selection database queries entry level job posts for minimum and preferred requirements and return to user opportunities that will fill into into six categories career exposure, professional network connections, skills and training, internship experiences, education and entry-level employment programs.

The system in its further embodiment allows social networking which is integrated into the system to facilitate career-planning and get support from adults, mentors, parents and school administrators. Users can also assign categories to those in their network to determine the strength of their network connections. Categories are the Sponsors, that can potentially make hiring decisions; Connectors are those that can potentially connect them to employment opportunities; Mentors are those that can provide professional mentoring but do not fall into Sponsor or Connector categories; and Peers are those who are on a similar career level.

The system of the software works in this way. For instance, consider a user who creates a profile stating that he/she is a current high school junior interested in studying Management Information Systems in college. The system queries the database and locates a Cyber Information Systems Security Analyst 1 position with Northrop Grumman. The job description cites basic qualifications as: bachelor's degree and current Top Secret/SCI clearance. Preferred qualifications as: DoD 8570 IAM Level 1 Certification, DoD 8570 IAT Level 1 Certification and 1-4 years of experience. The algorithm uses this information to suggest programs and opportunities in six categories identified above for user to attain the recommended qualifications.

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

1. A method of presenting users with employment career opportunities, wherein the method comprises:
an interface allowing user to logged in;
an interface allowing user to land on home screen;
an interface where the home screen on user screen allows them to select the sign-up option or log in option;
a user profile database that includes a plurality of user profiles comprising user specific data including user career interests;
a job postings database that includes a plurality of job posting entries;
a step of correlating one or more of said plurality of users with one or more of said plurality of job posting entries to increase user competitiveness for employment, wherein the step of correlating determines opportunities based on a category of one or more categories from a group consisting of: increasing user career exposure, expanding and increasing a user's network, enabling a user to obtain skills and/or training, exposing a user to available internships and research programs in order to enhance work experience, enable a user to attain education required for a particular career, and expose a user to entry-level career employment;
and, presenting said determined opportunities on a dashboard of said one or more or said plurality of users.
